(19) United States
(12) Patent Application Publication
(10) Pub. No.: US 2025/0196750 A1
(43) Pub. Date: Jun. 19, 2025

(54) RAMP DEVICE FOR VEHICLE

(71) Applicants: Hyundai Motor Company, Seoul (KR); Kia Corporation, Seoul (KR)

(72) Inventors: Dong Kyu Kim, Hwaseong-si (KR); Jiae Yong, Hwaseong-si (KR)

(21) Appl. No.: 18/928,540

(22) Filed: Oct. 28, 2024

(30) Foreign Application Priority Data
Dec. 18, 2023 (KR) 10-2023-0184117

(51) Int. Cl. B60P 1/43

(52) U.S. Cl. CPC B60P 1/435; B60P 1/431

(57) ABSTRACT

An embodiment ramp device for a vehicle includes a ramp frame inserted along a vehicle width direction into cross members of a floor structure of a vehicle body, wherein the ramp frame is configured to protrude at an incline toward a road surface direction from side ends of the floor structure.

### CROSS-REFERENCE TO RELATED APPLICATIONS

This application claims the benefit of Korean Patent Application No. 10-2023-0184117, filed on Dec. 18, 2023, which application is hereby incorporated herein by reference.

### TECHNICAL FIELD

The present invention relates to a ramp device for a vehicle.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle, and the PBV can provide various customized services to users while moving from the starting point to the destination in an unmanned autonomous driving method.

The vehicle body of these PBVs can be configured in various shapes and sizes depending on the user's use case. For example, the vehicle body of the PBV can be used as a hailing vehicle for transporting occupants or as a delivery vehicle for transporting goods.

Meanwhile, the hailing vehicle applies a sliding door to the side of the vehicle body to provide users with a wide and convenient boarding and disembarking space.

However, since these hailing vehicles have sliding door rails configured on the side sill of the vehicle body, it is difficult to apply reinforcing material to the side sill, and thus the side pole collision safety of the vehicle cannot be secured.

Furthermore, the hailing vehicle is applying a ramp device as a wheelchair boarding device for the transportation disadvantaged. Such ramp devices may, in one example, be embedded in the underfloor of a vehicle. Additionally, the ramp device may be stored in the trunk of the vehicle in a separate manner, as another example.

The information contained in this background section has been prepared to promote understanding of the background of embodiments of the invention and may include matters that are not already known prior art.

### SUMMARY

The present invention relates to a ramp device for a vehicle. Particular embodiments relate to a ramp device for a vehicle for the transportation disadvantaged.

Embodiments of the present disclosure provide a ramp device for a vehicle that can secure side pole collision performance while strengthening the connection with the vehicle body and securing ramp strength.

A ramp device for a vehicle mounted on a floor structure of a vehicle body is provided. The ramp device according to an embodiment may include a ramp frame which is inserted along the vehicle width direction into cross members of the floor structure and can be protruded inclined in a road surface direction from side ends of the floor structure.

The ramp frame may include at least two transverse members that are slidably coupled to the cross members along the vehicle width direction and a longitudinal member connected to the transverse members along the forward-backward direction of the vehicle body to support lateral ends of the floor structure.

The transverse members may be provided in a cross-section shape of an ‘inverted U’ with the top closed and the bottom open.

The transverse members may be slidably connected to an inside of a rail housing connected to the cross members along the vehicle width direction.

The rail housing and the transverse members may be provided as a floor reinforcement unit of the floor structure.

The longitudinal member may be disposed at a position corresponding to a door rail connected to a side sill of the floor structure and is provided as a side reinforcement unit of the floor structure.

The longitudinal member may include a closed cross-section of predetermined shape.

The ramp frame may further include a joint member that is mounted on an inner end of the transverse members that are inserted into the rail housing and can be joined to the side end of the rail housing.

The joint member may include a spring secured to at least one mounting part formed at the inner end of the transverse members and a ball plunger elastically supported by the spring and inserted into a connecting hole formed at the side end of the rail housing.

The transverse members may be fixed to the side end of the rail housing by the ball plunger connected to the connecting hole and may be rotatable toward the road surface with respect to the ball plunger.

The ramp device according to an embodiment may further include a ramp plate assembly that is stored on the floor structure and hinged to the side end of the floor structure.

The ramp plate assembly may be folded and stored between pairs of ribs formed in a floor panel of the floor structure.

The ramp plate assembly may include a flip plate hinged to the side ends of the ribs via a first hinge pin and a folding plate which is hinge-connected to the flip plate via a second hinge pin and is provided so as to be folded with the flip plate or unfolded from the flip plate.

A ramp device for a vehicle body including a chassis frame on which a battery is mounted and a floor structure coupled to the chassis frame is provided. The ramp device according to an exemplary embodiment mounted on the floor structure may include a ramp frame inserted along the vehicle width direction between a floor panel connected to a side sill of the floor structure and cross members connected to the floor panel, the ramp frame rotatably installed to a side end of the floor structure toward the road surface direction, and a ramp plate assembly, which is foldable and stored on the floor panel, hinged to the side end of the floor panel and provided so as to be unfoldable onto the ramp frame.

The ramp frame may include at least two transverse members slidably connected to an inside of a rail housing connected to the cross members along the vehicle width direction, a longitudinal member connected to the transverse members along the forward-backward direction of the vehicle body, and a joint member that is installed on an inner end of the transverse members that are inserted into the rail housing and is connected to the side end of the rail housing.

The rail housing and the transverse members may be provided as a floor reinforcement unit of the floor structure.

The longitudinal member may be disposed in a position corresponding to a door rail connected to the side sill and may be provided as a side reinforcement unit of the floor structure.

The ramp plate assembly may include a flip plate hinged to the side end of the floor panel and a folding plate that is hinge-connected to the flip plate and is equipped so as to be folded with the flip plate or unfolded.

A vehicle ramp device according to an embodiment of the present invention can secure the side pole collision performance of a PBV, contribute to weight reduction of the PBV, and implement thinning of the ramp plate and lowering of the vehicle boarding height.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of embodiments of the present invention should not be interpreted as limited to the attached drawings.

FIG. 1 is an exploded perspective view showing a vehicle body mount of a ramp device for a vehicle according to an embodiment.

FIG. 2 is a cross-sectional view illustrating a vehicle body mounting structure of a ramp device for a vehicle according to an embodiment.

FIG. 3 is an exploded perspective view illustrating a ramp device for a vehicle according to an embodiment.

FIG. 4 and FIG. 5 are cross-sectional views illustrating the mounting structure of a ramp frame applied to the ramp device for a vehicle according to an embodiment.

FIG. 6 is an exploded perspective view illustrating a joint member of a ramp frame applied to the ramp device for a vehicle according to an embodiment.

FIG. 7 is a cross-sectional view illustrating the joint member of the ramp frame applied to the ramp device for a vehicle according to an embodiment.

FIG. 8 is an exploded perspective view illustrating a ramp plate assembly applied to the ramp device for a vehicle according to an embodiment.

FIG. 9 to FIG. 11 are cross-sectional views illustrating the ramp plate assembly applied to the ramp device for a vehicle according to an embodiment.

The following reference identifiers may be used in connection with the drawings to describe various features of embodiments of the present invention.

| | |
|---|---|
| 1: vehicle body | 2: chassis frame |
| 3: floor structure | 4: side structure |
| 5: roof structure | 6: side sill |
| 7: floor panel | 8: front door |
| 9: sliding door | 11: battery |
| 13: cross member | 15: door rail |
| 17: road surface | 20: ramp frame |
| 21: transverse member | 23: longitudinal member |
| 25: joint member | 27: rail housing |
| 27a: closed section | 28: forming part |
| 29: flange | 31: closed cross-section |
| 33: floor reinforcement unit | 35: side reinforcement unit |
| 37: spring | 39: ball plunger |
| 41: mounting part | 43: connecting hole |
| 50: ramp plate assembly | 51: rib |
| 53: flip plate | 55: folding plate |
| 57: first hinge pin | 59: second hinge pin |
| 61: hinge member | 100: ramp device |

It should be understood that the drawings referenced above are not necessarily drawn to scale, but rather present rather simplified representations of various preferred features illustrating the basic principles of embodiments of the present invention. For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily implement embodiments of the present invention. As those skilled in the art would realize, the described embodiments may be modified in various different ways, all without departing from the spirit or scope of the embodiments of the present invention.

The terminology used herein is for the purpose of describing specific exemplary embodiments only and is not intended to limit the present disclosure. As used herein, the singular forms are intended to include the plural forms as well, unless the context clearly indicates otherwise.

In addition, in the detailed description below, the names of the components are divided into first, second, etc. to distinguish them when the components are in a similar relationship, and the description below is not necessarily limited to that order.

The terms ‘comprises’ and/or ‘comprising’ as used herein indicate the presence of specified features, integers, steps, operations, elements, and/or components, but they do not exclude the presence or addition of one or more other features, integers, steps, operations, components, and/or groups thereof.

As used in this specification, the term ‘and/or’ includes any one or all combinations of at least one of the associated listed items.

In this specification, the term ‘connected’ indicates a physical relationship between two components, for example, a relationship in which components are directly connected to each other by welding, self piercing rivet (SPR), flow drill screw (FDS), structural adhesive, or the like, or in which components are indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

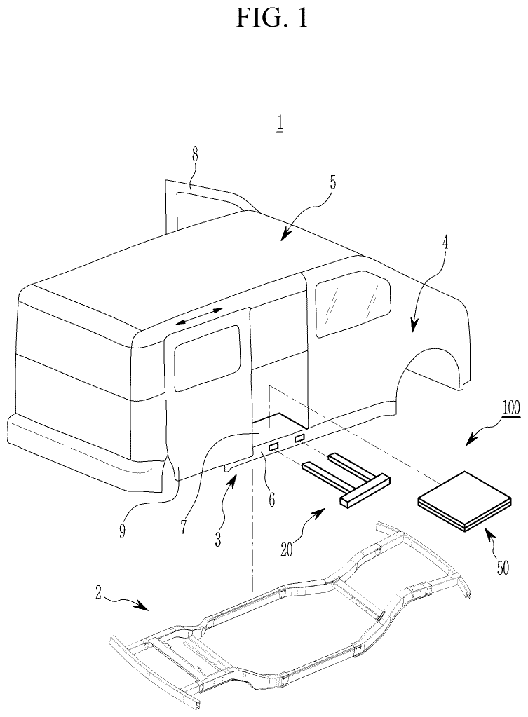

FIG. 1 is an exploded perspective view showing a vehicle body mount of a ramp device for a vehicle according to an embodiment.

Referring to FIG. 1, a ramp device 100 for a vehicle according to an embodiment can be applied to, for example, a vehicle body 1 of a purpose-based mobility vehicle (Purpose Built Vehicle: hereinafter referred to as a ‘PBV’).

The PBV may be used as an electric vehicle-based life module vehicle that provides various services to occupants while moving from one place to a destination in an unmanned self-driving manner. The above-mentioned life module vehicle is commonly called a ‘robo-taxi,’ ‘robo-shuttle,’ or ‘hailing vehicle’ by a person of ordinary skill in the art.

The PBV can be manufactured in a 1 box type design with a wide interior space. Furthermore, the PBV can also apply facing-type seats to the interior space. The vehicle body 1 of such a PBV can be manufactured in various shapes and sizes depending on the type of customized service of the PBV.

In this specification, the ‘forward-backward direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The vehicle body 1 of the PBV includes a chassis frame 2, a floor structure 3, a side structure 4, and a roof structure 5.

The chassis frame 2 may be, in one example, equipped as a skateboard type. A person of ordinary skill in the art also calls the chassis frame 2 a ‘rolling chassis.’

The floor structure 3 is connected to the chassis frame 2. The floor structure 3 includes side sills 6 arranged on each side of the vehicle body 1 in the vehicle width direction, and a floor panel 7 connected to the side sills 6.

The side structure 4 is connected to both sides of the floor structure 3. The side structure 4 may include a front door 8 mounted on one side in the vehicle width direction and a sliding door 9 mounted on the other side in the vehicle width direction.

And, the roof structure 5 is connected to the upper part of the side structure 4.

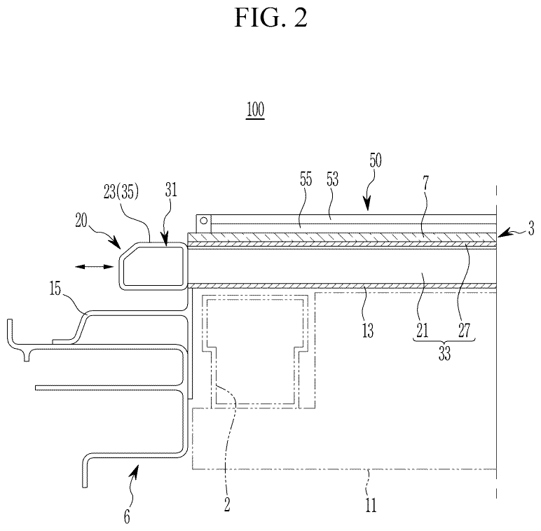

FIG. 2 is a cross-sectional view illustrating a vehicle body mounting structure of a ramp device for a vehicle according to an embodiment.

Referring to FIG. 1 and FIG. 2, in the vehicle body 1 as described above, a battery 11 is mounted on the chassis frame 2. Additionally, the floor structure 3 includes a plurality of cross members 13 connected along the vehicle width direction to the lower portion of the floor panel 7.

In the above vehicle body 1, a door rail 15 that can be combined with the sliding door 9 is connected to the side sill 6.

The ramp device 100 according to an embodiment is configured to allow a wheelchair user with a mobility impairment to enter or exit the vehicle.

The ramp device 100 according to an embodiment may be installed in the floor structure 3 of the vehicle body 1.

The ramp device 100 according to an embodiment of the present invention provides a structure that can secure side pole collision performance while strengthening connectivity with the vehicle body 1 and securing ramp strength and reducing vehicle step height.

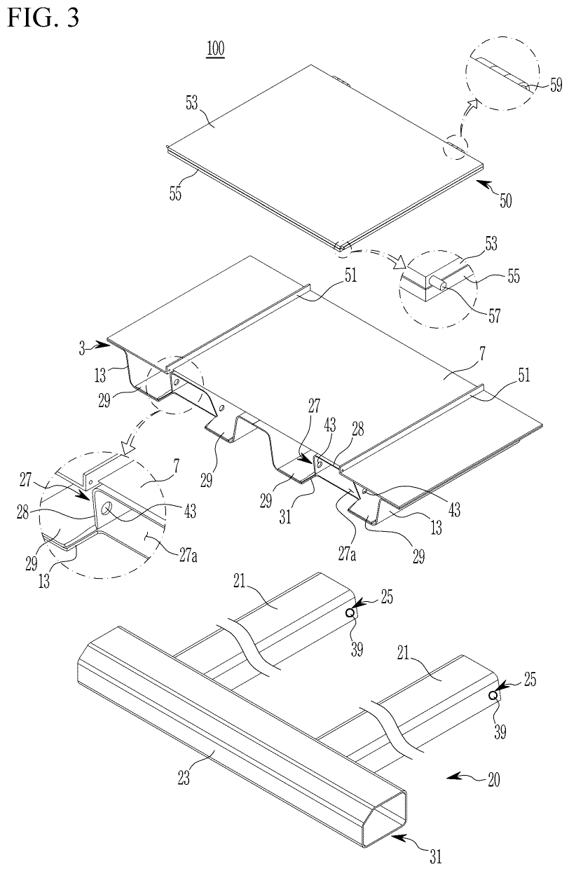

FIG. 3 is an exploded perspective view illustrating a ramp device for a vehicle according to an embodiment.

Referring to FIG. 1 to FIG. 3, the ramp device 100 according to an embodiment may include a ramp frame 20 and a ramp plate assembly 50.

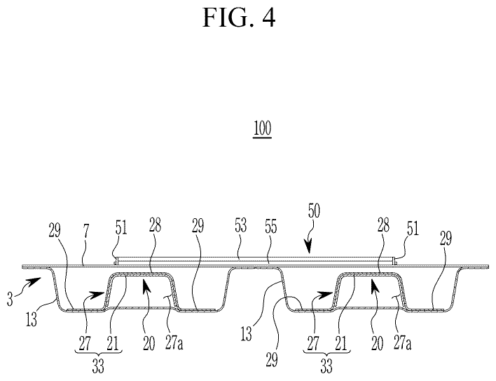

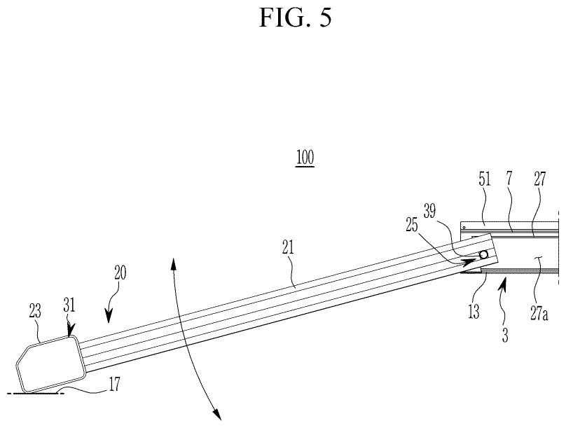

FIG. 4 and FIG. 5 are cross-sectional views illustrating the mounting structure of a ramp frame applied to the ramp device for a vehicle according to an embodiment.

Referring to FIG. 1 to FIG. 5, in an embodiment, the ramp frame 20 may be inserted along the vehicle width direction into the cross members 13 of the floor structure 3.

Additionally, the ramp frame 20 may be inclined from a side end of the floor structure 3 toward the road surface 17 direction.

That is, the ramp frame 20 can be inserted between the floor panel 7 and the cross members 13 along the vehicle width direction. Additionally, the ramp frame 20 can be rotatably installed to the side end of the floor structure 3 to the road surface 17.

The ramp frame 20 includes a plurality of transverse members 21, a longitudinal member 23, and a joint member 25.

In an embodiment, the transverse members 21 may be provided in at least two units. The drawing shows that the transverse members 21 are provided in two pieces, but is not limited thereto.

The transverse members 21 are connected to the cross members 13 so as to be slidingly connected along the vehicle width direction.

The transverse members 21 may be slidably arranged on the inside of a rail housing 27 connected along the vehicle width direction to each of the cross members 13. The rail housing 27 includes a forming part 28 and a flange 29.

The forming part 28 may be formed, in one example, into a cross-section shape of an ‘inverted U.’ Additionally, the flange 29 extends from each side of the forming part 28 and is connected to a lower inner surface of the cross members 13.

Accordingly, a closed section 27a may be formed between the lower inner surface of the cross members 13 and the forming part 28.

The transverse members 21 may slide in the vehicle width direction along the forming part 28 in the closed section 27a between the cross members 13 and the forming part 28.

The transverse members 21 may be provided in the cross-section shape of an ‘inverted U,’ for example, with the top closed and the bottom open.

In an embodiment, the longitudinal member 23 is connected to the transverse members 21 along the forward-backward direction of the vehicle body to support the side ends of the floor structure 3. The longitudinal member 23 is disposed in a position corresponding to the door rail 15.

The longitudinal member 23 may be provided in a tubular type, for example. The longitudinal member 23 includes a closed cross-section 31 of a predetermined shape.

Since the transverse members 21 are slidably connected to the rail housing 27, which is connected to the cross members 13 as described above to form a closed section 27a, along the vehicle width direction, the rail housing 27 and the transverse members 21 may be provided as a floor reinforcement unit 33 of the floor structure 3 (see FIG. 2 and FIG. 4).

In addition, the longitudinal member 23 is provided as a tubular type with a closed cross-section 31 and is configured to support the side end of the floor structure 3, so it can be provided as a side reinforcement unit 35 of the floor structure 3 (see FIG. 2).

In an embodiment, the joint member 25 is configured to secure the ramp frame 20 drawn out from the rail housing 27 to the side end of the rail housing 27.

Additionally, the joint member 25 is configured to rotate the ramp frame 20, which is drawn out from the rail housing 27, from the side end of the rail housing 27 toward the road surface 17.

The joint member 25 is mounted on an inner end of the transverse members 21 which are inserted into the rail housing 27 and may be joined to the side end of the rail housing 27.

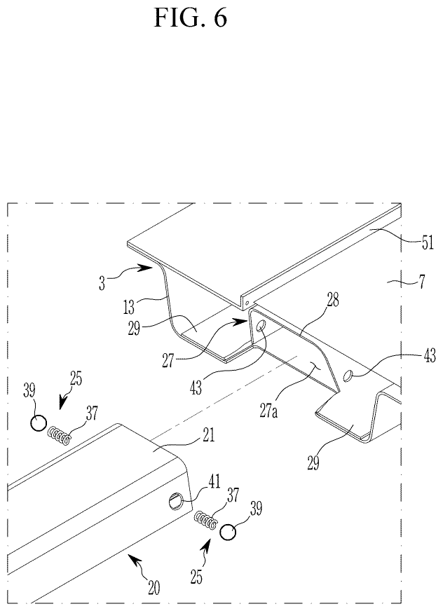

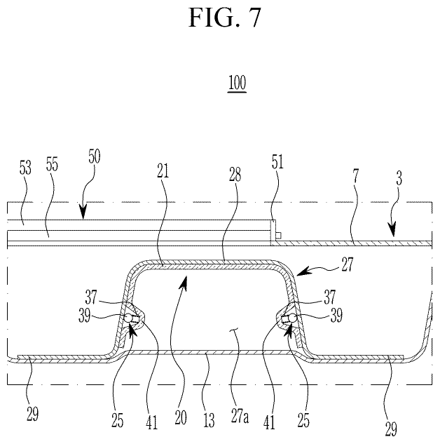

FIG. 6 is an exploded perspective view illustrating a joint member of a ramp frame applied to the ramp device for a vehicle according to an embodiment, and FIG. 7 is a cross-sectional view illustrating the joint member of the ramp frame applied to the ramp device for a vehicle according to an embodiment.

Referring to FIG. 6 and FIG. 7, the joint member 25 according to an embodiment may include a spring 37 and a ball plunger 39.

The spring 37 is fixed to at least one mounting part 41 formed on the inner end of the transverse members 21. The spring 37 may, in one example, include a compression coil spring.

The ball plunger 39 is provided in a ball shape and is elastically supported by the spring 37 in at least one mounting part 41.

The ball plunger 39 may be moved inwardly of the mounting part 41 by the inner surface of the rail housing 27 when the transverse members 21 of the ramp frame 20 are introduced into or drawn out from the inner side of the rail housing 27.

And, when the transverse members 21 are drawn out from the inside of the rail housing 27 and the inner end of the transverse members 21 is positioned at the side end of the rail housing 27, the ball plunger 39 may be connected to the connecting hole 43 formed at the side end of the rail housing 27 by the elastic force of the spring 37.

The ball plunger 39 is protruded from the mounting part 41 by the elastic force of the spring 37 and may be inserted into the connecting hole 43.

Therefore, when the ramp frame 20 is drawn out from the rail housing 27, the transverse members 21 may be secured to the side end of the rail housing 27 by the ball plunger 39 connected to the connecting hole 43.

And, with the transverse members 21 fixed to the side end of the rail housing 27, the transverse members 21 may be rotated toward the road surface 17 together with the longitudinal member 23 with respect to the ball plunger 39. Accordingly, the ramp frame 20 may be arranged to be inclined toward the road surface 17 at the side end of the rail housing 27.

Referring to FIG. 1 to FIG. 3, in an embodiment, the ramp plate assembly 50 is extended from the side end of the rail housing 27 onto the ramp frame 20 that is arranged to be inclined toward the road surface 17, thereby forming a slope on which a wheelchair may travel.

The ramp plate assembly 50 is folded and stored on the upper part of the floor structure 3, hinged to the side end of the floor structure 3, and provided so as to be unfoldable onto the ramp frame 20.

The ramp plate assembly 50 may be folded and stored between pairs of ribs 51 formed on the floor panel 7 of the floor structure 3.

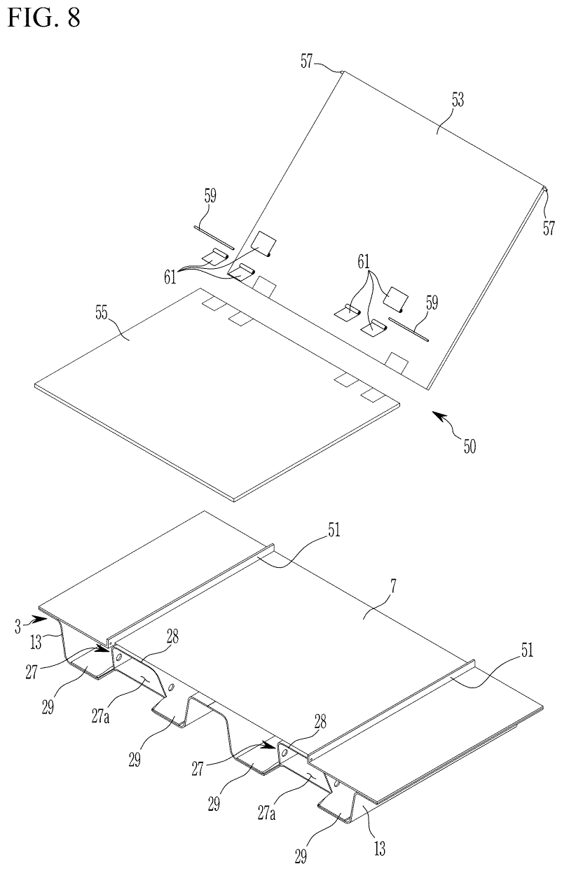

FIG. 8 is an exploded perspective view illustrating a ramp plate assembly applied to the ramp device for a vehicle according to an embodiment.

Referring to FIG. 8, the ramp plate assembly 50 according to an embodiment includes a flip plate 53 and a folding plate 55.

The flip plate 53 may be provided in the form of a thin plate. The flip plate 53 is hinge-connected to the side end of the ribs 51 via at least one first hinge pin 57 at the side end of the floor panel 7.

Additionally, the folding plate 55 may be provided in the form of a thin plate. The folding plate 55 is hinge-connected to the flip plate 53 and is provided to be folded and unfolded with the flip plate 53.

The folding plate 55 is hinged to the flip plate 53 via at least one second hinge pin 59 and may be folded with or unfolded from the flip plate 53.

The flip plate 53 may be positioned on the transverse members 21 of the ramp frame 20 by rotating via at least one first hinge pin 57. Additionally, the folding plate 55 may be positioned on the transverse members 21 by rotating through at least one second hinge pin 59.

In FIG. 8, drawing reference numeral 61 indicates hinge members that are configured to hinge-connect the flip plate 53 and the folding plate 55. These hinge members 61 are obvious to those skilled in the art, so a detailed description is omitted.

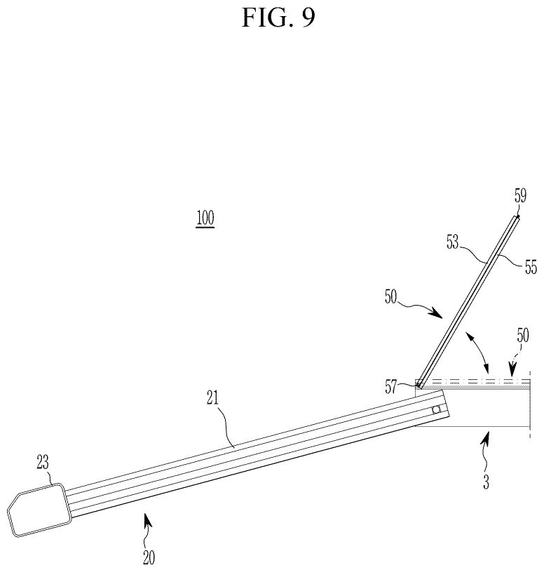

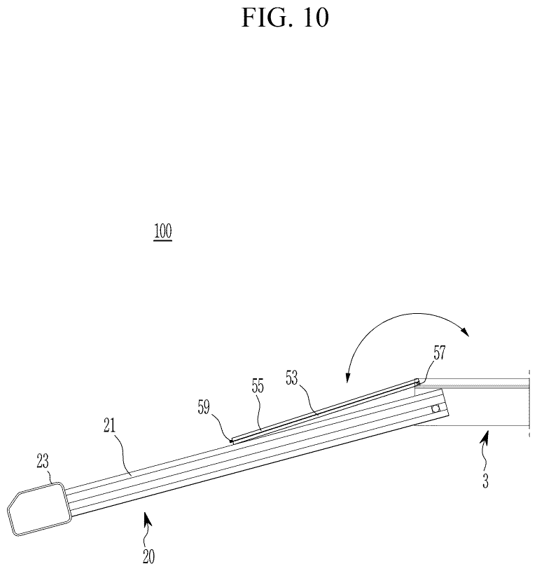

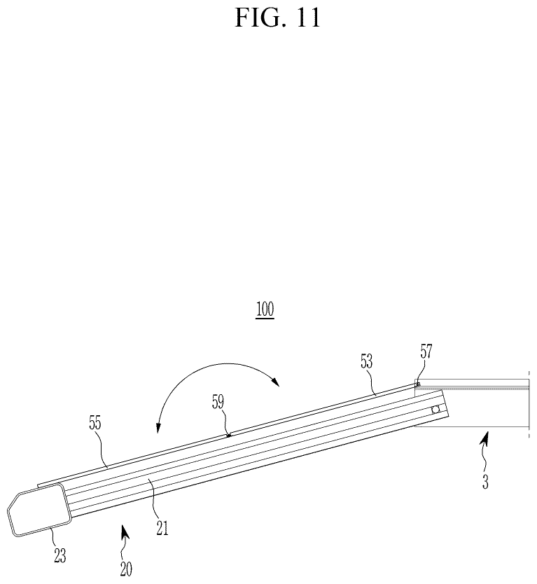

FIG. 9 to FIG. 11 are cross-sectional views illustrating the ramp plate assembly applied to the ramp device for a vehicle according to an embodiment.

Hereinafter, the operation of the ramp device 100 according to an embodiment configured as described above will be described in detail with reference referring to FIG. 1 to FIG. 11.

In an embodiment, the transverse members 21 of the ramp frame 20 are inserted into the inside of the rail housing 27 connected to each of the cross members 13 along the vehicle width direction.

The transverse members 21 are introduced along forming part 28 into the closed section 27a formed between the lower inner surface of the cross members 13 and the forming part 28 of the rail housing 27.

Additionally, the longitudinal member 23 of the ramp frame 20 connects the transverse members 21 along the forward-backward direction of the vehicle body 1 and supports the side end of the floor structure 3.

The longitudinal member 23 forms a closed cross-section 31 of a predetermined shape and is positioned corresponding to the door rail 15.

Additionally, in an embodiment, the flip plate 53 and the folding plate 55 of the ramp plate assembly 50 are stored between the pair of ribs 51 of the floor panel 7 while in a folded state. Accordingly, the ramp plate assembly 50 may be utilized as the floor surface of the floor panel 7.

Furthermore, the flip plate 53 is hinged to the side ends of the ribs 51 via the first hinge pin 57. Additionally, the folding plate 55 is hinge-connected to the flip plate 53 via the second hinge pin 59.

In this state, in order to get a wheelchair occupied by a person with a mobility impairment into or out of the vehicle, the user holds the longitudinal member 23 of the ramp frame 20 and pulls it outward toward the side of the floor structure 3 along the vehicle width direction.

Then, the transverse members 21 are drawn outward along the rail housing 27 to the outside of the floor structure 3.

The spring 37 of the joint member 25 is fixed to the mounting part 41 formed on the inner end of the transverse members 21, and the ball plunger 39 is elastically supported by the spring 37.

As described above, when the transverse members 21 are drawn out, the ball plunger 39 is inserted into the mounting part 41 by the inner surface of the rail housing 27 and slips onto the inner surface of the rail housing 27.

Next, when the inner end of the above-mentioned transverse members 21 is positioned at the side end of the rail housing 27, the ball plunger 39 is inserted into the connecting hole 43 formed at the side end of the rail housing 27. That is, the ball plunger 39 is protruded from the mounting part 41 by the elastic force of the spring 37 and inserted into the connecting hole 43.

Accordingly, the transverse members 21 are secured to the side end of the rail housing 27 by the ball plunger 39 connected to the connecting hole 43.

In this state, the transverse members 21 may be rotated toward the road surface 17 together with the longitudinal member 23 with respect to the ball plunger 39. Accordingly, the ramp frame 20 may be arranged to be inclined toward the road surface 17 at the side end of the rail housing 27.

The flip plate 53 of the ramp plate assembly 50, which is stored on the floor panel 7, can be rotated upward together with the folding plate 55 with respect to the first hinge pin 57 by the user while it is overlapped with the folding plate 55 (e.g., in a folding state).

Then, the folding plate 55 is rotated outwardly on the side of the floor structure 3 via the second hinge pin 59 and is unfolded away from the flip plate 53.

Accordingly, the flip plate 53 and the folding plate 55 are placed on the transverse members 21 of the ramp frame 20, and the slope is formed from the side end of the floor structure 3 toward the road surface 17 by the ramp frame 20.

Accordingly, a wheelchair carrying a mobility-disadvantaged person can travel along the flip plate 53 and the folding plate 55 and can board or disembark from the vehicle.

According to an embodiment of the ramp device 100 as described so far, the closed section 27a is formed between the cross members 13 and the rail housing 27, and the transverse members 21 of the ramp frame 20 may slide along the closed section 27a.

And, according to an embodiment of the ramp device 100, the longitudinal member 23 is provided as a tubular type with the closed cross-section 31 and is configured to support the side end of the floor structure 3.

Accordingly, the rail housing 27 and the transverse members 21 can be provided as the floor reinforcement unit 33 of the floor structure 3, and the longitudinal member 23 can be provided as the side reinforcement unit 35 of the floor structure 3.

In this way, the ramp device 100 according to an embodiment can strengthen the connection between the ramp frame 20 and the vehicle body 1 and secure the strength of the floor structure 3.

Accordingly, the ramp device 100 according to an embodiment can improve the side pole collision performance of a PBV and minimize damage to the battery 11 caused by the side pole collision.

Additionally, the ramp device 100 according to an embodiment can secure the side pole collision performance of the PBV, thereby eliminating a separate reinforcing material mounted on the chassis frame.

Therefore, the ramp device 100 according to an embodiment can contribute to weight reduction of the PBV.

Furthermore, since the ramp device 100 according to an embodiment can support the load applied to the ramp plate assembly 50 through the ramp frame 20, the ramp strength can be secured and the flip plate 53 and the folding plate 55 can be made into thin plates.

Furthermore, the ramp device 100 according to an embodiment can store the flip plate 53 and the folding plate 55, which are thin plates that can be folded and unfolded, on the floor panel 7, thereby enabling a lowering of the vehicle boarding height.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A ramp device for a vehicle, the ramp device comprising:
a ramp frame inserted along a vehicle width direction into cross members of a floor structure of a vehicle body, wherein the ramp frame is configured to protrude at an incline toward a road surface direction from side ends of the floor structure.

2. The ramp device of claim 1, wherein the ramp frame comprises:
a plurality of transverse members slidably coupled to the cross members along the vehicle width direction; and
a longitudinal member connected to the transverse members along a forward-backward direction of the vehicle body and configured to support lateral ends of the floor structure.

3. The ramp device of claim 2, wherein the transverse members have a cross-section shape of an ‘inverted U’ with a top portion closed and a bottom portion open.

4. The ramp device of claim 2, wherein the transverse members are slidably connected to an inside of a rail housing connected to the cross members along the vehicle width direction.

5. The ramp device of claim 4, wherein the rail housing and the transverse members comprise a floor reinforcement unit of the floor structure.

6. The ramp device of claim 5, wherein the longitudinal member is disposed at a position corresponding to a door rail connected to a side sill of the floor structure and comprises a side reinforcement unit of the floor structure.

7. The ramp device of claim 6, wherein the longitudinal member has a closed cross-section of a predetermined shape.

8. The ramp device of claim 4, wherein the ramp frame further comprises a joint member mounted on an inner end of the transverse members that are inserted into the rail housing and joinable to the side ends of the rail housing.

9. The ramp device of claim 8, wherein the joint member comprises:
a spring secured to a mounting part disposed at the inner end of the transverse members; and
a ball plunger elastically supported by the spring and inserted into a connecting hole disposed at the side end of the rail housing.

10. The ramp device of claim 9, wherein the transverse members are fixed to the side end of the rail housing by the ball plunger connected to the connecting hole and are rotatable toward the road surface direction with respect to the ball plunger.

11. A ramp device for a vehicle, the ramp device comprising:
a ramp frame inserted along a vehicle width direction into cross members of a floor structure of a vehicle body, wherein the ramp frame is configured to protrude at an incline toward a road surface direction from side ends of the floor structure; and
a ramp plate assembly stored on the floor structure and hinged to the side ends of the floor structure.

12. The ramp device of claim 11, wherein the ramp plate assembly is folded and stored between pairs of ribs disposed in a floor panel of the floor structure.

13. The ramp device of claim 12, wherein the ramp plate assembly comprises:
a flip plate hinged to side ends of the ribs via a first hinge pin; and
a folding plate hinge-connected to the flip plate via a second hinge pin and disposed so as to be folded with the flip plate or unfolded from the flip plate.

14. The ramp device of claim 11, wherein:
the vehicle body comprises a chassis frame on which a battery is mountable;
the floor structure is coupled to the chassis frame;
the ramp frame is inserted along the vehicle width direction between a floor panel connected to a side sill of the floor structure and the cross members connected to the floor panel;
the ramp frame is rotatably installed to the side ends of the floor structure toward the road surface direction; and
the ramp plate assembly is foldable and stored on the floor panel in a folded state and is unfoldable onto the ramp frame in an unfolded state.

15. The ramp device of claim 14, wherein the ramp frame comprises:
a plurality of transverse members slidably connected to an inside of a rail housing connected to the cross members along the vehicle width direction;
a longitudinal member connected to the transverse members along a forward-backward direction of the vehicle body; and
a joint member disposed on an inner end of the transverse members that are inserted into the rail housing and connected to the side end of the rail housing.

16. The ramp device of claim 15, wherein:
the rail housing and the transverse members are parts of a floor reinforcement unit of the floor structure; and
the longitudinal member is disposed in a position corresponding to a door rail connected to the side sill and is part of a side reinforcement unit of the floor structure.

17. The ramp device of claim 14, wherein the ramp plate assembly comprises:
a flip plate hinged to the side end of the floor panel; and
a folding plate hinge-connected to the flip plate and configured to be folded with the flip plate or unfolded.

18. A vehicle comprising:
a vehicle body comprising:
a chassis frame on which a battery is mountable; and
a floor structure coupled to the chassis frame, the floor structure comprising a side sill, a floor panel connected to the side sill, and cross members connected to the floor panel; and
a ramp device mounted on the floor structure, the ramp device comprising:
a ramp frame inserted along a vehicle width direction between the floor panel connected to the side sill of the floor structure and the cross members connected to the floor panel, wherein the ramp frame is rotatably installed to a side end of the floor structure toward a road surface direction; and
a ramp plate assembly hinged to the side end of the floor panel, wherein in a folded state, the ramp plate assembly is folded and stored on the floor panel, and wherein in an unfolded state, the ramp plate assembly is unfoldable onto the ramp frame.

19. The vehicle of claim 18, wherein:
the ramp frame comprises:
a plurality of transverse members slidably connected to an inside of a rail housing connected to the cross members along the vehicle width direction;
a longitudinal member connected to the transverse members along a forward-backward direction of the vehicle body; and
a joint member disposed on an inner end of the transverse members that are inserted into the rail housing and connected to the side end of the rail housing; and
the ramp plate assembly comprises:
a flip plate hinged to the side end of the floor panel; and
a folding plate hinge-connected to the flip plate and configured to be folded with the flip plate or unfolded.

20. The ramp device of claim 19, wherein:
the rail housing and the transverse members are parts of a floor reinforcement unit of the floor structure; and
the longitudinal member is disposed in a position corresponding to a door rail connected to the side sill and is part of a side reinforcement unit of the floor structure.
